(19) United States
(12) Patent Application Publication
(10) Pub. No.: US 2022/0032738 A1
(43) Pub. Date: Feb. 3, 2022

(54) AIR VENT

(71) Applicant: fischer automotive systems GmbH & Co. KG, Horb a.N. (DE)

(72) Inventor: Gunter LEOPOLD, Baiersbronn (DE)

(21) Appl. No.: 17/367,452

(22) Filed: Jul. 5, 2021

(30) Foreign Application Priority Data
Jul. 29, 2020 (DE) 10 2020 120 053.6
Dec. 3, 2020 (DE) 10 2020 132 204.6

(51) Int. Cl. B60H 1/34

(52) U.S. Cl. CPC B60H 1/3421; B60H 2001/3471

(57) ABSTRACT

Provided are damping swivel and pivot bearings of an operating element of an air vent for a passenger compartment of a motor vehicle, for example, individually and independently of one another by way of an elastic friction element.

### CROSS-REFERENCE TO RELATED APPLICATIONS

This application claims priority under 35 USC § 119 to German Patent Application Nos. 10 2020 120 053.6, filed Jul. 29, 2020, and 10 2020 132 204.6, filed Dec. 3, 2020, the entire disclosures of which are incorporated herein by reference.

### TECHNICAL FIELD OF THE INVENTION

The invention relates to an air vent. The invention is not limited to motor vehicles, but rather the air vent can be used arbitrarily for guiding an air current.

### DISCUSSION OF THE RELATED ART

Air vents are used to supply air to a passenger compartment of a motor vehicle. They are installed, for example in a recessed manner, in an instrument panel of a motor vehicle so that an air outlet opening opens into a passenger compartment of the motor vehicle.

For example, air vents comprise two louvers arranged behind one another in a direction of flow of an air current through the air vent, for laterally deflecting the air current. “Lateral” shall also mean a vertical deflection in the case of a horizontal air current. Each louver comprises multiple blades that can jointly be pivoted in parallel, wherein the blades of the two louvers intersect one another so that the air current through the air vent can be deflected in two directions. The blades are comparable to control surfaces used in control surface mechanisms of airplanes, wherein, for example, one louver is used to horizontally deflect the air current, and the other louver is used to vertically deflect the air current.

In addition, air vents are known which comprise blades that are rigidly connected to and intersect one another, which can jointly be two-dimensionally rotated and/or pivoted so as to be able to laterally deflect the air current through the air vent in a two-dimensional manner.

Pivotable flaps (dampers) and displaceable slides are known for controlling a volume of air flowing through the air vent, by way of which a flow cross-section of the air vents can be blocked to varying degrees and, if necessary, completely.

The blades and the like can, generally speaking, be referred to as “air guide elements”, and the flaps, slides and the like can, generally speaking, be referred to as “air volume control elements.”

The patent application DE 10 2017 126 563 A1 describes an air vent for a motor vehicle, comprising an annular air guide element including a blade that rigidly extends through the air guide element in a radial plane. The air guide element, including the blade thereof, can be pivoted about a radial axis and rotated about the axis thereof so as to guide an air current through the air vent in a two-dimensional manner. An elastic, ball socket-shaped friction element, which damps, by way of friction, the pivoting movement of the air guide element about the radial axis, is disposed between a ball-shaped head and a ball socket, which form part of a pivot mounting of the air guide element.

### SUMMARY OF THE INVENTION

It is the object of the invention to provide an air vent comprising a multi-dimensionally friction-damped operating element for moving air guide elements and/or air volume control elements.

The air vent according to the invention comprises at least two, and preferably three, rotatorily and/or translatorily movable air guide elements and/or air volume control elements, which can be moved by way of gear mechanisms using a manually movable operating element. “Rotatory” shall mean a rotational or pivoting movement, wherein “pivoting” shall mean a rotation having a limit rotational or pivot angle. “Translatory” shall mean a linear or non-linear displacement. “Operating element” means an element including an operating surface for manual operation, as well as all parts that are rigidly connected to the operating surface.

The air vent comprises a multi-axis guide comprising at least two guides and preferably a three-axis guide comprising three guides, which guide the operating element in at least two, and preferably three, axial directions in a rotatorily and/or translatorily movable manner. The guides can be pivot or swivel bearings and/or sliding guides, for example. The three axial directions in which the operating element can be moved are rotational or pivot axes of the pivot or swivel bearings and/or sliding directions in which the sliding guides movably guide the operating element.

The gear mechanisms can be pinion, lever, cam, cable pull and/or belt gear mechanisms, for example. The list is by way of example and not exhaustive. The gear mechanisms transmit the movement of the operating element to the air guide elements and/or air volume control elements, wherein these can reduce or increase the transmission ratio of the movement, change a movement direction and/or convert a rotatory movement into a translatory movement, or vice versa. In addition, the gear mechanisms distribute the movement of the operating element, as a function of the movement direction thereof, to the air guide elements and/or air volume control elements. In particular, each axial direction of the multi-axis guide of the operating element is assigned an air guide element and/or air volume control element.

According to the invention, the air vent, or the multi-axis guide or three-axis guide of the operating element includes a dedicated friction damping system for each guide, so that the movement of the operating element can be damped differently (or also identically) in each axial direction. “Dedicated friction damping system” thus means a functional separation of the damping assemblies, but not necessarily separate components. A “friction damping system” shall mean a means by which a frictional effect is regularly generated, which in particular goes beyond the technologically inevitable minimum friction in conventional bearings. In particular, the friction damping system comprises a friction element.

In particular, the friction damping systems comprise friction elements that are disposed at or in the guides and/or at the operating element and that, during a movement of the operating element, cause friction in the guides, or between movable elements of the guides, and/or the operating element on the one hand, and with respect to the movable elements of the guides and/or of the operating element and immovable parts of the guides or of the air vent on the other hand, for damping the movement of the operating element. In particular, friction elements are rigidly connected to the movable elements, the operating element or the immovable elements or parts, so that no play and, to the extent possible, no elasticity, exists between the friction elements and the operating element, which would degrade the damping of the movement of the operating element. In particular, the operating element is damped directly, and not indirectly by way of joints or the like.

The friction elements can be designed as one part or more parts. In particular, it is possible that friction elements of multiple guides are designed as one friction part.

One embodiment of the invention provides a pivot or swivel bearing, comprising a bearing shaft that is rotatably or pivotably mounted in a bearing hole, to serve as a guide of the operating element in an axial direction of the multi-axis guide or three-axis guide of the operating element. The air vent according to the invention can comprise pivot or swivel bearings for multiple axes of the multi-axis guide or three-axis guide thereof. The operating element or another guide of the multi-axis guide or three-axis guide is integrally or rigidly connected to the bearing shaft or a part including the bearing hole. An elastic friction element is inserted in the bearing hole between the bearing shaft and the bearing hole and rests with a friction-generating preload against the bearing shaft and/or in the bearing hole. The friction element is non-rotatable with respect to the bearing shaft or the bearing hole, in particular without play. In particular, the friction element is an elastic sleeve or an elastic cylindrical shell, which is inserted in the bearing hole between the bearing shaft and the bearing hole.

One embodiment of the invention provides a sliding guide to serve as a guide of the operating element, which displaceably guides the operating element, in a linear or non-linear manner, in an axial direction of the multi-axis guide or three-axis guide of the operating element. The air vent according to the invention can comprise sliding guides for multiple axes of the multi-axis guide or three-axis guide thereof. The operating element or another guide of the multi-axis guide or three-axis guide is integrally or rigidly connected to a part of the sliding guide. An elastic friction element is inserted between two parts of the sliding guide which are movable with respect to one another and rests with a friction-generating preload against the one part of the sliding guide and is, in particular non-displaceably, connected to a part of the sliding guide which is movable with respect to the one part of the sliding guide.

One embodiment of the invention provides a kind of gimbal mounting as part of the multi-axis guide or three-axis guide of the operating element, wherein axial directions can be orthogonal, but do not have to be. In this embodiment of the invention, the multi-axis guide or three-axis guide comprises a ring, which is rotatably or pivotably mounted about a first axis by way of a first pivot or swivel bearing. A second pivot or swivel bearing mounts an inner bearing element, which is disposed in the ring, rotatably or pivotably about a second axis in or at the ring. The inner bearing element comprises a third pivot or swivel bearing, which mounts the operating element rotatably or pivotably about a third axis. The ring can be circular, different from circular round and/or angular, for example rectangular.

The features and feature combinations, embodiments and configurations of the invention mentioned above in the description, and the features and feature combinations mentioned hereafter in the description of the figures and/or shown in a figure, can be used not only in the respective indicated or illustrated combination, but also in other essentially arbitrary combinations, or alone. Embodiments of the invention that do not include all the features of a dependent claim are possible. It is also possible to replace individual features of a claim with other disclosed features or feature combinations. Embodiments of the invention that do not include all the features of the exemplary embodiment, but an essentially arbitrary portion of the characterizing features of the exemplary embodiment, are possible.

### BRIEF DESCRIPTION OF THE DRAWINGS

The invention will be described hereafter in greater detail based on one exemplary embodiment shown in the drawings. In the drawings:

FIG. 1 shows inner parts of a first exemplary embodiment of an air vent according to the invention, without housing, in a perspective illustration;

FIG. 2 shows a perspective axial section of individual parts of the air vent from FIG. 1;

FIG. 3 shows a perspective exploded view of individual parts of the air vent from FIG. 1;

FIG. 4 shows inner parts of a second exemplary embodiment of an air vent according to the invention, without housing, in a perspective illustration;

FIG. 5 shows the inner parts of the air vent from FIG. 4 with a different viewing direction;

FIG. 6 shows a cross-sectional illustration of a detail from FIG. 5; and

FIG. 7 shows a slide of an air deflection of the air vent from FIGS. 4 and 5.

### DETAILED DESCRIPTION OF THE EMBODIMENTS

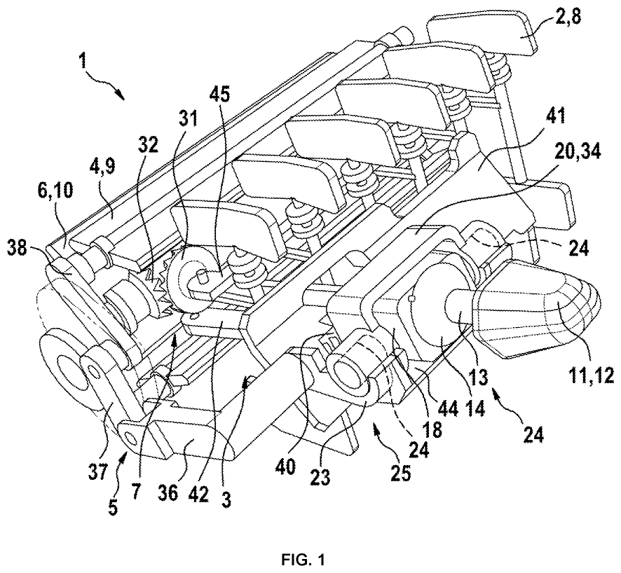

FIG. 1 shows an air vent 1 according to the invention, without housing, serving to illustrate the mechanics thereof and the individual parts thereof, in particular the movable parts thereof. The air vent 1 comprises plate-shaped first blades 2, which are disposed parallel to and at a distance next to one another and which can jointly be pivoted in parallel by way of a first gear mechanism 3. In a direction of flow through the air vent 1 upstream of the first blades 2, two strip-shaped second blades 4 are disposed transversely to the first blades 2, and parallel to and, at a distance, on top of one another, which can likewise jointly be pivoted by way of a second gear mechanism 5. Pivot axes of the first and second blades 2, 4 run transversely to one another. Using the first and second blades 2, 4, an air current through the air vent 1 can be deflected in a two-dimensional manner transversely to the flow direction.

In addition, the air vent 1 comprises two dampers 6 in the flow direction upstream of the second blades 4, which can jointly be pivoted in opposite pivot directions about mutually parallel pivot axes by way of a third gear mechanism 7. When the dampers 6 are pivoted together, these are aligned in the direction of flow through the air vent 1 so that the air current can flow through the air vent 1. When the dampers 6 are pivoted apart, these block air from passing through the air vent 1, to varying degrees depending on the pivot position thereof, thereby controlling an air volume flowing through the air vent 1. When the dampers 6 are pivoted completely apart, these block the air vent 1 completely.

The first and second blades 2, 4 can, generally speaking, also be interpreted as first and second air guide elements 8, 9, and the dampers 6 can, generally speaking, also be interpreted as air volume control elements 10. In particular instead of the pivotable dampers 6, the air vent 1 according to the invention can also comprise displaceable damper slides, serving as air volume control elements 6 (not shown). The air guide elements 8, 9 can likewise be displaceable instead of pivotable (not shown).

The air vent 1 is intended for recessed installation in an instrument panel of a motor vehicle, for example, so that an air outlet opening of the air vent 1 is flush with the instrument panel, and an air current through the air vent 1 can be guided into a passenger compartment of the motor vehicle.

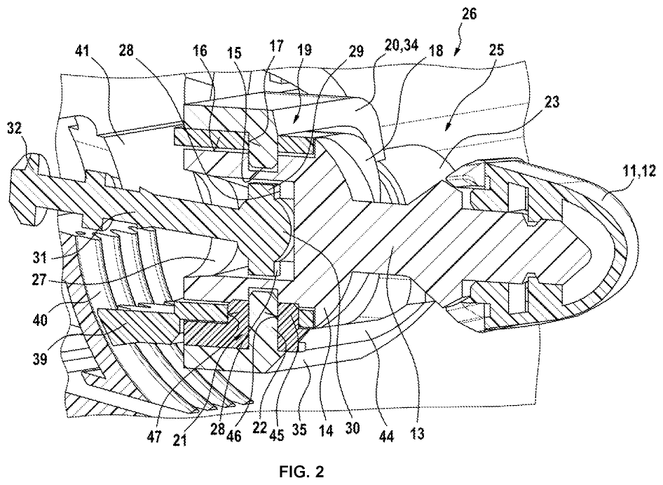

For pivoting or, generally speaking, for moving the air guide elements 8, 9 and the air volume control elements 10, the air vent 1 comprises an operating element 11, which can be gripped using fingers and moved by hand and which, at an end facing the operator, has the shape of a knob 12, which is pyramid-like in the exemplary embodiment. The knob 12 is rigidly connected via a shaft 13 to a foot 14 of the operating element 11, which can be rotated or pivoted about three axes that are orthogonal with respect to one another. In a center position of the operating element 11 shown in FIGS. 1 and 2, the shaft 13 runs orthogonally with respect to the pivot axes of the first and second blades 2, 4 and the dampers 6. The operating element 11 is disposed downstream of the first blades 2, in the direction of flow through the air vent 1, so as to be grippable at the knob 12 for occupants in the passenger compartment of the motor vehicle.

The foot 14 of the operating element 11 includes a circumferential first groove 15, which is concentric to the shaft 13, in a radial plane of the shaft 13, and a cylindrical surface 16, which is coaxial to the shaft 13 (FIG. 2). The cylindrical surface 16 and, together therewith, the entire operating element 11, is mounted rotatably about a longitudinal axis of the shaft 13 of the operating element 11 in a bearing hole 17 of an inner bearing element 18. The cylindrical surface 16 and the bearing hole 17 form a pivot bearing 19 for the operating element 11, wherein the foot 14, together with the cylindrical surface 16, can also be interpreted as a bearing shaft of the pivot bearing 19.

The inner bearing element 18 is pivotably mounted in a ring 20, which is rectangular in the exemplary embodiment. As a first swivel bearing 21, the ring 20 comprises two first bearing pins 22, which coaxially project inwardly at opposite points and which extend through bearing holes 17 of the inner bearing element 18 and engage in the circumferential first groove 15 in the foot 14 of the operating element 11. The first bearing pins 22 can also be interpreted as the bearing shaft of the first pivot bearing 21. A pivot axis of the first swivel bearing 21 intersects the rotational axis of the pivot bearing 19.

Two bearing bushings 23 project coaxially from the ring 20 outwardly at opposite points, which are rotatably or pivotably mounted on second bearing pins 24 fixed to the housing. The second bearing pins 24 can likewise be interpreted as a bearing shaft of a second swivel bearing 25, by way of which the ring 20 is pivotably mounted.

The pivot bearing 19 and the two swivel bearings 21, 25 form a three-axis mount, by way of which the operating element 11 is rotatorily mounted pivotably or rotatably about three axes. In the exemplary embodiment, the pivot and rotational axes of the three-axis mount are orthogonal to one another. In embodiments of the invention, the pivot bearing 19 and/or one or both swivel bearings 21, 25 can be replaced with sliding guides (not shown), which is why the three-axis mount of the operating element 11 can, generally speaking, also be interpreted as a three-axis guide 26, which guides the operating element 11 in a rotatorily and/or translatorily movable manner in three dimensions.

The foot 14 of the operating element 11, opposite the shaft 13, includes a blind hole 27, which is coaxial to the shaft 13 and which is open on a side facing the first and second blades 2, 4 and the dampers 6. The blind hole 27 includes two second grooves 28 located opposite one another in an axial plane of the blind hole 27 and of the shaft 13. Two pins 29 engage in the second grooves 28, which coaxially project from a ball-shaped head 30 opposite one another, which is located in the blind hole 27 and is rigid with a shaft 31, which comprises a first bevel gear 32 at the end thereof located furthest from the ball-shaped head 30. The pins 29 of the ball-shaped head 30 of the shaft 31 engaging in the second grooves 28 in the blind hole 27 of the foot 14 of the operating element 11 connect the shaft 31 to the operating element 11 non-rotatably and pivotably about the pivot axes of the swivel bearings 21, 25 of the operating element 11, so that the first bevel gear 32 can be rotatably driven by way of the shaft 31 by a rotation of the operating element 11.

The shaft 31 passes between the first and second blades 2, 4. The first bevel gear 32 meshes with two second bevel gears 33, which are disposed coaxially opposite one another and which are rigidly disposed at the dampers 6 coaxially with the pivot axes thereof, so that the dampers 6 can be pivoted apart and together by rotation of the operating element 11. The non-rotatable ball-shaped head 30 in the foot 14 of the operating element 11, the shaft 31 and the bevel gears 32, 33 form the third gear mechanism 7 for pivoting the dampers 6, which form the air volume control elements 10 of the air vent 1 according to the invention, by a rotation of the operating element 11.

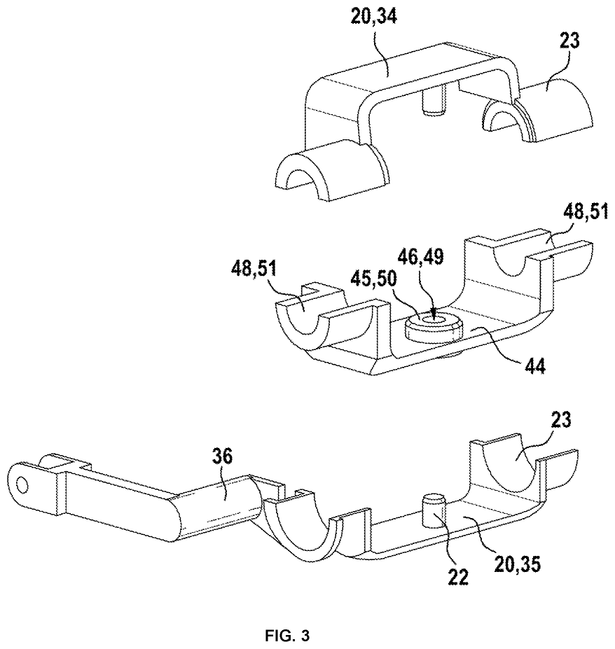

The rectangular ring 20 is split in two in an axial plane of the second swivel bearing 25 thereof, to form two semi-rings 34, 35, which can be seen as individual parts in the exploded view of FIG. 3. An elbowed lever 36, which is to say angled twice by 90° in opposite directions, projects rigidly from the lower of the two semi-rings 35 and is connected in an articulated manner, by way of two strip-shaped transmission members 37 that are connected to the lever in an articulated manner, to radial levers 38, which project rigidly and radially with respect to the pivot axes from the two second blades 4, so that the two second blades 4 can jointly be pivoted by pivoting of the ring 20. The ring 20 is pivoted about the pivot axis of the second swivel bearing 25 of the ring 20 by pivoting of the operating element 11, wherein this pivoting movement is transmitted by the first bearing pins 22, which coaxially project inwardly from the ring 20 and which engage in the circumferential first groove 15 in the foot 14 of the operating element 11, from the operating element to the ring 20. The elbowed lever 36, the transmission members 37 and the radial levers 38 form the second gear mechanism 5, by way of which the second blades 4, by pivoting of the operating element 11, can jointly be pivoted about the pivot axis of the second swivel bearing 25 of the ring 20. The rectangular ring 20, including the inwardly projecting first bearing pins 22 thereof, and the foot 14 of the operating element 11, including the circumferential first groove 15, can be interpreted as parts of the second gear mechanism 5.

A toothed rack 39 projects rigidly from the inner bearing element 18 in the direction of the first blades 2. The toothed rack 39 extends concentrically in a circular arc-shaped manner around the first bearing pins 21 projecting inwardly from the ring 20, and meshes with a mating tooth system 40, which extends parallel to an imaginary plane through the pivot axes of the first blades 2. Teeth of the mating tooth system 40 extend in a circular arc-shaped manner concentrically to the pivot axis of the second swivel bearing 25, by way of which the ring 20 is pivotably mounted, so that the toothed rack 39, during pivoting about the pivot axis of the second swivel bearing 25, remains in engagement with the mating tooth system 40. The mating tooth system 40 is rigidly connected to a slide 41, which is displaceably guided, parallel to the imaginary plane through the pivot axes of the first blades 2, in the housing (not shown) of the air vent 1. A rigid lever 42 projects rigidly from the slide 41, which passes between the first blades 2 and is connected in an articulated manner to a coupling rod 43, which engages on the first blades 2 in an articulated manner, so that the first blades 2 can jointly be pivoted in parallel by a displacement of the slide 41. The slide 41 is displaced by way of the toothed rack 39 and the mating tooth system 40, by pivoting of the operating element 11 about the pivot axis of the first swivel bearing 21, by way of which the inner bearing element 18 is pivotably mounted in the ring 20. The toothed rack 39, the mating tooth system 40, the rigid lever 42 and the coupling rod 43 form the first gear mechanism 3, by way of which the first blades 2, by pivoting of the operating element 11, can jointly be pivoted in parallel about the pivot axis of the first swivel bearing 21.

An elastic friction part 44 made of an elastomer is disposed in the lower semi-ring 35 of the ring 20, which is shown as an individual part in FIG. 3. The friction part 44 includes an annular elevation 45, which surrounds a hole 46 in the friction part 44. The hole 46 surrounds one of the two first bearing pins 22, which project inwardly from the ring 20. The elevation 45 of the friction element 44 extends through a radial through-hole 47 in the inner bearing element 18 and rests with preload in the through-hole 47, thereby damping, by way of friction, a pivoting movement of the operating element 11 about the pivot axis of the first swivel bearing 21, by way of which the inner bearing element 18 is pivotably mounted in the ring 20. This portion of the friction part 44 thus forms a first friction element 49. In addition, an end face of the elevation 45 rests with preload against the cylindrical surface 16 of the foot 14 of the operating element 11, so as to damp, by way of friction, the rotation of the operating element 11 about the longitudinal axis of the shaft 13 thereof. This portion of the friction part 44 thus forms a second friction element 50. The preload with which the elevation 45, including the first friction element 49, rests in the through-hole 47 of the inner bearing element 18, and the preload with which the second friction element 50 rests against the cylindrical surface 16, can be selected to be different in terms of magnitude, so that the degrees of friction damping of the pivoting movement and of the rotation of the operating element 11 can be set or established independently of one another.

Cylindrical shells 48, namely half shells, project outwardly from the friction part 44 at opposite points, which surround the second bearing pins 24 in the bearing bushings 23 of the second swivel bearing 25 of the ring 20 over half the circumference thereof. The elastic cylindrical shells 48 of the friction part 44 rest with preload against the insides of the first bearing pins 22, and against the outsides of the bearing bushings 23, thereby damping, by way of friction, the pivoting of the ring 20, and thus the pivoting of the operating element 11, about the pivot axis of the second swivel bearing 25. The cylindrical shells 48 of the friction part 44 thus form a third friction element 51. As a result of the preload of the cylindrical shells 48 in the bearing bushings 23, the damping of the second swivel bearing 25 can likewise be set or established independently of the damping of the first swivel bearing 21 of the inner bearing element 18 in the ring 20 and the damping of the rotation of the operating element 11. Instead of one friction part 44 for all pivot and swivel bearings 19, 21, 25 or, generally speaking, for the guides of the operating element 11, the air vent 1 according to the invention can also comprise one friction part for two of the three pivot and swivel bearings 19, 21, 25, or for two of the three guides of the operating element 11, or one friction part for each of the three pivot and swivel bearings 19, 21, 25, or for each of the three guides of the operating element 11 (not shown).

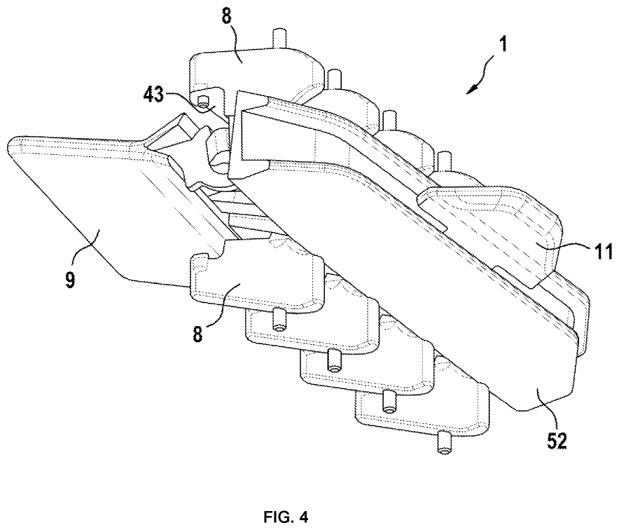

The following description of FIGS. 4 to 7 uses identical reference numerals as in FIGS. 1 to 3 for elements that coincide with FIGS. 1 to 3.

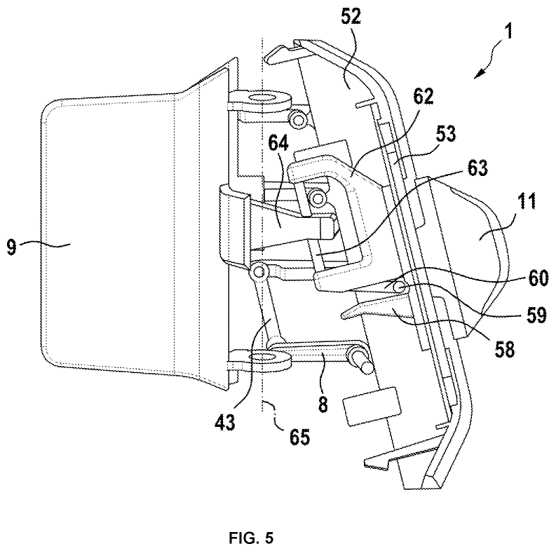

As in FIG. 1, FIGS. 4 and 5 show an air vent 1 according to the invention without housing or a movement mechanism for guiding an air current through the air vent 1.

The air vent 1 from FIGS. 4 and 5 comprises an elongated sliding panel 52, which is disposed in a stationary manner in a rectangular air outlet opening (not shown) of the air vent 1, so that air can flow out above and beneath the sliding panel 52. The sliding panel 52 includes a slot in which an operating element 11 is disposed, which can be gripped and moved, for example, using a thumb and an index finger of a hand. On a back of the sliding panel 52, parallel to the slot, a round rod 53 is disposed, on which the operating element 11 is displaceably guided and pivotably mounted. For this purpose, the operating element 11 comprises a sliding bearing sleeve 54, which in the exemplary embodiment is an integral part of the operating element 11. Multi-piece embodiments are possible.

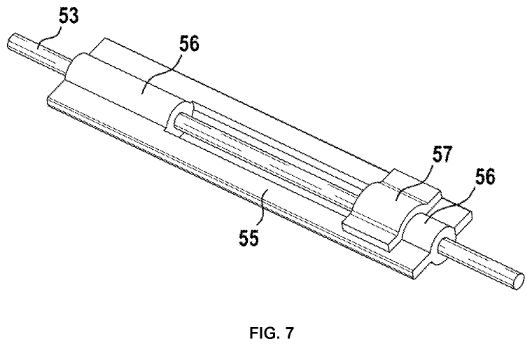

A strip-shaped carriage 55, which includes a longitudinal slot in which the round rod 53 is exposed, is likewise provided on the round rod 53. The carriage 55 comprises coaxial sliding bearing sleeves 56 on both sides of the operating element 11, by way of which the carriage is displaceably guided and rotatably mounted on the round rod 53. As a result of the carriage 55 comprising sliding bearing sleeves 56 on both sides of the operating element 11, the carriage is displaced jointly with the operating element 11. The carriage 55 on the round rod 53 is shown individually in FIG. 7.

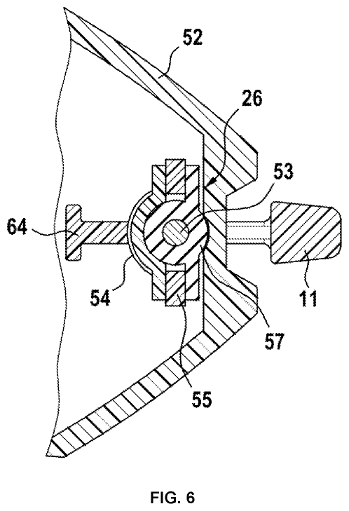

A friction element 57 is disposed in the slot of the carriage 55, which is the only friction element 57 of the operating element 11 of the air vent 1 from FIGS. 4 and 5. As is apparent in FIG. 6, the friction element 57 comprises a cylindrical tube-shaped sleeve including a strip-shaped foot in a plane tangential to the sleeve. The friction element 57 can also be interpreted as being Ω-shaped. The sleeve surrounds the round rod 53, and the foot is inserted between the carriage 55 and the sliding panel 52. The friction element 57 is made of an elastomer and is rubber-elastic.

The foot of the friction element 57 rests with a preload against the sliding panel 52, thereby damping, by way of friction, displacement of the carriage 55 and of the operating element 11. In addition, or instead, the sleeve of the friction element 57 can have an undersized dimension relative to the round rod 53, so as to damp, by way of friction, the movement of the carriage 55 and of the operating element 11 using the round rod 53.

The sleeve of the friction element 57 is inserted with axial preload in the slot of the carriage 55, which due to the strip shape thereof rests non-rotatably against the sliding panel 52. As a result of friction at the end face thereof with the sliding bearing sleeve 54 of the operating element 11 or, generally speaking, with the operating element 11, the friction element 57 damps the rotation or a pivoting of the operating element 11 on the round rod 53. Even though the air vent 1 comprises only one friction element 57 for the operating element 11, the friction element 57 damps the rotation of the operating element 11, regardless of the displacement of the operating element 11. Expressed in general terms, the friction element 57 damps the movement of the operating element 11 in two axial directions, one of which is the displacement and another is the rotation in the exemplary embodiment, independently of one another. An axial length of the friction element 57 or of the sleeve thereof is, among other things, decisive for damping the rotation of the operating element 11, and a thickness of the foot of the friction element 57 and/or an inside diameter of the sleeve of the friction element 57 is decisive for damping the displacement of the operating element 11.

The round rod 53 and the sliding bearing sleeve 54 of the operating element 11 form a multi-axis guide 26, which guides the operating element 11 in two axial directions. In the exemplary embodiment, the multi-axis guide 26 is a two-axis guide, one axis of which is displacement in the axial direction of the round rod 53, and the other axis of which is rotation about the round rod 53.

A first fork 58, which surrounds a crank pin 59 on both sides, projects rigidly from the operating element 11 on a back of the sliding panel 52. The crank pin 59 rigidly connects two cranks 60, which are congruent as viewed in an axially parallel manner, to one another, from the outer sides of which, facing away from one another, two crankshafts 61 project coaxially, which are rotatably mounted in the housing (not shown) of the air vent 1. The cranks 60 can jointly be pivoted by displacement of the operating element 11.

Plate-shaped and mutually parallel first air guide elements 8 are rigidly disposed on the crankshafts 61, which pivot along with the cranks 60. Coupling rods 43 connect the first air guide elements 8, which are rigidly disposed on the crankshafts 61, to further first air guide elements 8, which are disposed parallel to and at a distance next to one another, so that all first air guide elements 8 can jointly be pivoted in parallel by displacement of the operating element 11. By pivoting of the first air guide elements 8, an air current can be guided laterally through the housing (not shown) of the air vent 1. The first fork 58 and the cranks 60 form a first gear mechanism 3, or are part of such a first gear mechanism 3, of the air vent 1, which movably connects the first air guide elements 8 to the operating element 11, so that the first air guide elements 8 can jointly be moved, or pivoted in the exemplary embodiment, by a movement of the operating element 11, or by a displacement in the exemplary embodiment. This movement is damped by way of friction of the friction element 57, as described above.

The operating element 11 comprises a second fork 62 on the back of the sliding panel 52. For the purpose of installation in the slot of the sliding panel 52, the operating element 11 and the second fork 62 are designed as two pieces, however the second fork 62 is rigidly connected to the operating element 11, so as to move along with the operating element 11, similarly to the first fork 58.

At a distance from the round rod 53, the second fork 62 comprises a rod 63 that is parallel to the round rod 53 and that moves, during pivoting of the operating element 11 on the round rod 53, on a circular arc around the round rod 53.

The rod 63 is inserted in a third fork 64, which projects rigidly from a plate-shaped second air guide element 9, which is pivotably mounted about a pivot axis 65 in the housing (not shown) of the air vent 1. The pivot axis 65 of the second air guide element 9 can extend parallel to the round rod 53. In the exemplary embodiment, the pivot axis 65 extends obliquely to the round rod 53, so that the second air guide element 9 of the air vent 1 can be pivoted about a pivot axis 65 that is oblique with respect to a pivot axis and sliding direction of the operating element 11.

The second air guide element 9 is pivoted, by pivoting of the operating element 11, on the round rod 53, wherein the pivoting movement is transmitted via the second fork 62 and the third fork 64. The second fork 62 and the third fork 64 form a second gear mechanism 5, or are part of such a second gear mechanism 5, of the air vent 1, which movably connects the second air guide elements 9 to the operating element 11, so that the second air guide element 9 can be moved, or pivoted in the exemplary embodiment, by moving the operating element 11, or by pivoting in the exemplary embodiment. This movement is damped, as described above, by way of friction of the friction element 57, regardless of the movement of the first air guide elements 8 by way of the first gear mechanism 3.

### LIST OF REFERENCE NUMERALS

### Air Vent

1 air vent
2 first blade
3 first gear mechanism
4 second blade
5 second gear mechanism
6 damper
7 third gear mechanism
8 first air guide element
9 second air guide element
10 air volume control element
11 operating element
12 knob
13 shaft
14 foot
15 first groove
16 cylindrical surface
17 bearing hole
18 inner bearing element
19 pivot bearing
20 ring
21 first swivel bearing
22 first bearing pin
23 bearing bushing
24 second bearing pin
25 second swivel bearing
26 three-axis guide
27 blind hole
28 second groove
29 pin
30 ball-shaped head
31 shaft
32 first bevel gear
33 second bevel gear
34 upper semi-ring
35 lower semi-ring
36 elbowed lever
37 transmission member
38 radial lever
39 toothed rack
40 mating tooth system
41 slide
42 rigid lever
43 coupling rod
44 friction part
45 elevation
46 hole
47 through-hole
48 cylindrical shell
49 first friction element
50 second friction element
51 third friction element
52 sliding panel
53 round rod
54 sliding bearing sleeve
55 carriage
56 sliding bearing sleeve
57 friction element
58 first fork
59 crank pin
60 crank
61 crankshaft
62 second fork
63 rod
64 third fork
65 pivot axis

1. An air vent, comprising at least two movable air guide elements and/or air volume control elements, comprising a manually movable operating element for moving the air guide elements and/or air volume control elements, comprising gear mechanisms, which movably connect the operating element to the air guide elements and/or air volume control elements for moving the air guide elements and/or air volume control elements, comprising a multi-axis guide, which comprises at least two guides that movably guide the operating element rotatorily and/or translatorily in at least two axial directions, and comprising a friction damping system, which damps, by way of friction, the movement of the operating element, wherein the air vent comprises a dedicated friction damping system for each guide of the multi-axis guide of the operating element.

2. The air vent according to claim 1, wherein the air vent comprises three movable air guide elements and/or air volume control elements, a manually movable operating element for moving the air guide elements and/or air volume control elements, gear mechanisms, which movably connect the operating element to the air guide elements and/or air volume control elements for moving the air guide elements and/or air volume control elements, a three-axis guide, which comprises three guides that movably guide the operating element rotatorily and/or translatorily in three axial directions, and a friction damping system, which damps, by way of friction, the movement of the operating element, and the air vent comprises a dedicated friction damping system for each guide of the three-axis guide of the operating element.

3. The air vent according to claim 1, wherein the friction damping comprises a friction element, which damps the movement of the operating element in multiple or in all axial directions.

4. The air vent according to claim 1, wherein the friction damping systems comprise friction elements, which are disposed at the guides and/or at the operating element and which, during movement of the operating element, cause friction between movable parts of the guides and/or the operating element on the one hand, and parts of the air vent that are immovable in relation thereto on the other hand.

5. The air vent according to claim 1, wherein a guide of the operating element comprises a pivot or swivel bearing, including a bearing hole in which a bearing shaft is rotatably or pivotably mounted, an elastic friction element being inserted into the bearing hole, which rests with a friction-generating preload against the bearing shaft and/or in the bearing hole.

6. The air vent according to claim 5, wherein the friction element is an elastic sleeve or an elastic cylindrical shell, which is inserted in the bearing hole between the bearing shaft and the bearing hole.

7. The air vent according to claim 3, wherein a guide of the operating element comprises a sliding guide, and the sliding guide comprises a friction element, which rests with a friction-generating preload against an element of the sliding guide which is movable with respect to the friction element.

8. The air vent according to claim 1, wherein the three-axis guide comprises a ring, which is mounted rotatably or pivotably about a second axis by way of a second swivel bearing, and which comprises a first swivel bearing, which mounts an inner bearing elements disposed in the ring pivotably about a first axis, the inner bearing element comprising a pivot bearing which mounts the operating element rotatably about a third axis.
